(19) United States
(12) Patent Application Publication
(10) Pub. No.: US 2026/0311983 A1
(43) Pub. Date: Oct. 8, 2026

(54) CAPACITOR AS ALTERNATIVE TO POWER SUPPLY FOR LOW LEAKAGE CURRENT ION OPTICS ELEMENTS IN MASS SPECTROMETERS

(71) Applicant: Thermo Finnigan LLC, San Jose, CA (US)

(72) Inventors: Oleg Silivra, San Jose, CA (US); Linfan Li, San Jose, CA (US)

(73) Assignee: Thermo Finnigan LLC, San Jose, CA (US)

(21) Appl. No.: 19/578,709

(22) Filed: Mar. 25, 2026

Related U.S. Application Data
(60) Provisional application No. 63/784,865, filed on Apr. 7, 2025.

(51) Int. Cl. H01J 49/02; H01J 43/20

(52) U.S. Cl. CPC H01J 49/025; H01J 43/20

(57) ABSTRACT

Ion detection systems include a high energy conversion dynode network including at least one high energy conversion dynode situated in a vacuum chamber, and a high voltage source coupled or couplable to the high energy conversion dynode network to selectively charge the high energy conversion dynode, wherein the ion detection system is configured to use charge stored by the high energy conversion dynode network to detect ions while the high energy conversion dynode is not being charged by the high voltage source. Methods include charging a high energy conversion dynode situated in a vacuum chamber and that is part of a high energy conversion dynode network, using a high voltage source, and detecting an ion with the high energy conversion dynode using the charge stored by the high energy conversion dynode network, while the high energy conversion dynode is not being charged by the high voltage source.

### CROSS REFERENCE TO RELATED APPLICATION

This application claims the benefit of U.S. Provisional Patent Application No. 63/784,865, filed Apr. 7, 2025, and is incorporated by reference herein.

### FIELD

The field is mass spectrometry and ion detection.

### BACKGROUND

Mass spectrometers and other ion analysis instruments can employ high energy conversion dynodes (HECDs) in their ion detection subsystems. While HECDs can be useful to increase the sensitivity of the instrument for detection of larger ions, they can increase system complexity and require expensive and bulky electronics to supply the high voltages required by the HECD to function correctly. Accordingly, a need remains for improved instruments and methods.

### SUMMARY

Disclosed examples can leverage a capacitance provided by the HECD and associated HECD network with respect to the instrument ground to store and provide charge for the HECD. The charge can be stored and provided for a duration sufficient to continue ion detection while the HECD is not being actively charged by a coupled high-voltage source. In some examples, the HECD can be coupled to a capacitor coupled to a ground, with the capacitor configured to store and provide charge for a similar duration, e.g., so that the HECD can remain operable even without the high voltage source actively charging it.

According to an aspect of the disclosed technology, an ion detection system includes a high energy conversion dynode network including at least one high energy conversion dynode situated in a vacuum chamber, and a high voltage source coupled or couplable to the high energy conversion dynode network to selectively charge the high energy conversion dynode, wherein the ion detection system is configured to use charge stored by the high energy conversion dynode network to detect ions while the high energy conversion dynode is not being charged by the high voltage source.

According to another aspect of the disclosed technology, methods of detecting ions with an ion detection system include charging a high energy conversion dynode situated in a vacuum chamber and that is part of a high energy conversion dynode network, using a high voltage source, and detecting an ion with the high energy conversion dynode using the charge stored by the high energy conversion dynode network, while the high energy conversion dynode is not being charged by the high voltage source.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1 is a schematic of an example detection system that uses a high energy conversion dynode (HECD).

FIGS. 2A-2B are a chromatogram graph and mass spectrum graph, respectively, according to an experiment.

FIGS. 3A-3C are a chromatogram graph and mass spectrum graphs, respectively, according to another experiment.

FIG. 4 is a schematic of an example detection instrument for detecting ions, such as a mass spectrometer.

FIG. 5 is a schematic of a voltage conversion arrangement that can be used with various disclosed examples.

FIG. 6 is a schematic of a power transmission arrangement that can be used with various disclosed examples.

FIG. 7 illustrates an ion detection system and techniques for increasing capacitance.

FIG. 8 is a flowchart of a method of operating various disclosed examples.

### DETAILED DESCRIPTION

Ion detection in the mass spectrometer can often rely on a conversion dynode which converts incident ions that impact the surface of the dynode into a “shower” of secondary particles. This can have the advantage of amplifying the signal and enabling the detection of both cations and anions (sequentially) in a single hardware setup. The dynode is typically held at several to tens of kV, and the corresponding power supply is often expensive and bulky. Disclosed examples can leverage the surprising effect that the electrical network around the dynode can cause retention of the high voltage for a significant duration after the power supply is decoupled from the dynode. In some examples, additional elements (e.g., capacitors) added to the circuit improve this effect still further. As a result, ion detectors disclosed herein can be configured to provide satisfactory detection capability while using cheaper power supply configurations and/or improved portable or compact mass spectrometry instruments. In selected examples, detection systems can be used in triple quadrupole and linear ion trap mass spectrometers.

While disclosed examples can be applied to detectors for mass spectrometers and mass spectrometry more generally, examples can also be applied to other constant voltage devices in mass spectrometers. Also, additional examples can include a wider class of devices which require a constant voltage, and which have very low leakage current. For example, in addition to high energy conversion dynodes, disclosed charging techniques and arrangements can be applied to high voltage scintillators in detection systems, high voltage ion optics elements with low leakage current (e.g., lenses, deflectors, focusing assemblies, etc.), high voltage devices in instruments other than mass spectrometers, low voltage devices in systems restricted in size and resources, and power transmission arrangements in which a power supply powers multiple devices switching from one device to another in a loop.

Detection systems in many contemporary mass spectrometers use an HECD to provide primary conversion of incoming ions into secondary particles processed by a subsequent detector. To provide nearly lossless conversion for incoming ions within a wide range of m/z values, HECDs are usually kept at a relatively high voltage of several kV (e.g., 5 kV to about 30 kV). This voltage is typically provided by a dedicated high-voltage power supply (HVPS) that feeds the HECD through the corresponding infrastructure. However, it has been discovered that an ion signal can continue to be received from a detector after disconnection of a high-voltage cable feeding the HECD. The ion signal can persist for several minutes after HVPS cable disconnection. This effect can be attributed to the capacitance of the HECD network, such as including but not limited to the high voltage feedthrough, the HECD, and/or wiring connecting the feedthrough and HECD. In an example, after disconnection of a HVPS cable from a feedthrough, this capacitance retains enough charge to allow the HECD to remain at a voltage that enables efficient ion signal detection.

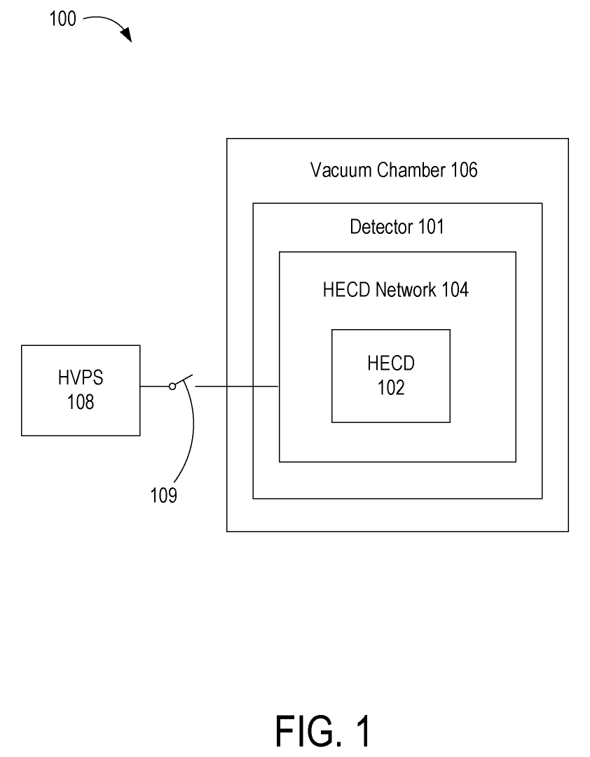

FIG. 1 is an example detection system 100 that includes a detector 101. The detector 101 includes an HECD 102 that is part of an HECD network 104. The HECD 102 is typically a conductive structure that is configured to be charged to a high voltage and arranged to accelerate and receive ions to cause ion impacts with its surface and thereby emit secondary particles. The HECD network 104 can include, e.g., wiring configured to deliver charge to the HECD 102. The HECD 102 is situated in a vacuum chamber 106 to receive ions to perform ion detections. Some or all of the HECD network 104 can be situated in the vacuum chamber 106. A high voltage power supply 108 can be coupled to the HECD network 104 to supply charge and high voltage to the HECD 102. The high voltage power supply 108 can be situated outside and/or inside the vacuum chamber 106 (shown outside in FIG. 1 for convenience of illustration). After the HECD 102 is powered by the high voltage power supply 108, the HECD 102 can be operable to receive ions during the ion detection process by using charge and voltage provided by the HVPS. The charge and voltage used by the HECD 102 for detection can continue to be supplied by a capacitance of the HECD 102 and associated HECD network 104 after the high voltage power supply 108 is disconnected, e.g., at a switch 109, or is no longer charging the HECD 102. In various examples, disconnecting and/or cessation of charging can include mechanical disconnection, electrical pulsing between on and off, or turning off power supply. As shown, the switch 109 is situated outside the vacuum chamber 106 but it will be appreciated that various examples include one or more switches inside the vacuum chamber 106, or switches both inside and outside the vacuum chamber 106. In many examples, the inclusion of the switch 109 can reduce charge leak paths between the HECD network 104 and ground or elsewhere.

The capacitance can include a mutual capacitance between the HECD 102 (and HECD network 104) and nearby instrument surfaces, such as surfaces of the vacuum chamber 106 or other device surfaces, such as an electron multiplier, quadrupole, etc. In some examples, a capacitor can be coupled between the HECD 102 and/or HECD network 104 and a ground (e.g., within the vacuum chamber 106 or externally through a feedthrough) to provide at least a portion of the capacitance. The duration over which the HECD 102 can remain operable for the detection process can vary based on the capacitance, component characteristics, and vacuum chamber conditions though in many examples it can be sufficient for normal detection operation (e.g., seconds, minutes, tens of minutes, etc.). This can allow the high voltage power supply 108 to be less complex, more lightweight, and/or less expensive, which can advantageously reduce cost, increase portability, and improve robustness of the detection system 100.

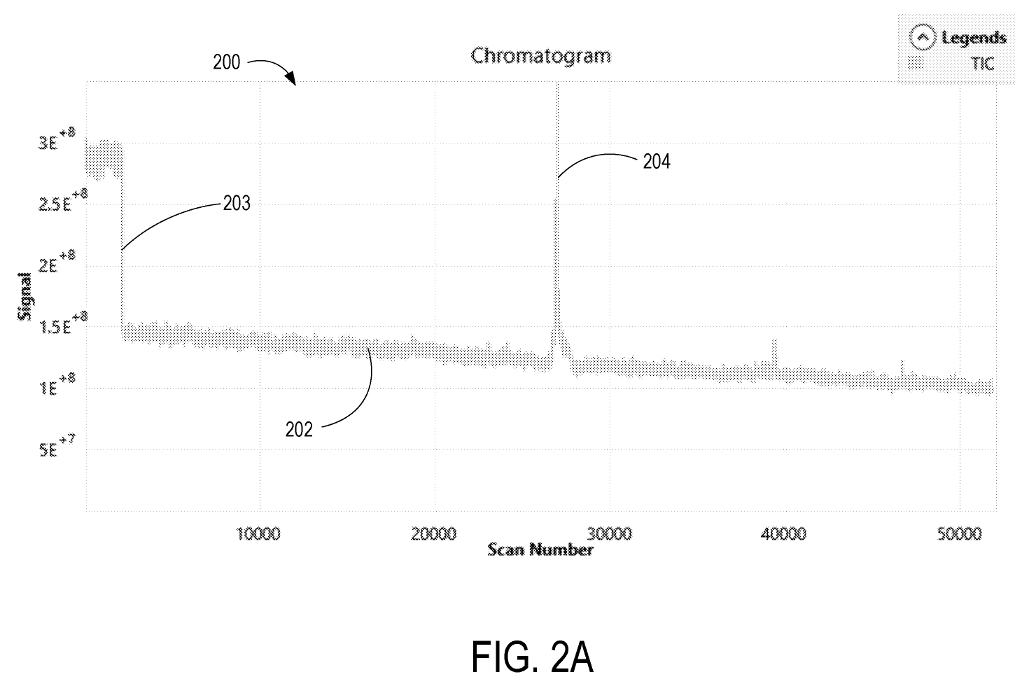

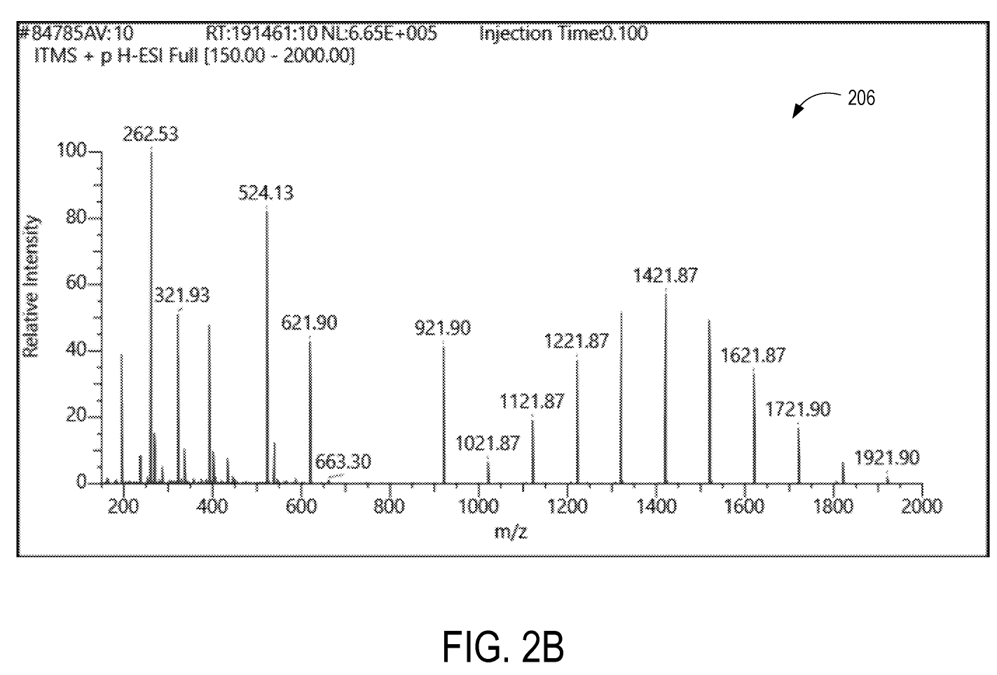

FIG. 2A is an example chromatogram graph 200 showing the capacitive operability of an example detection system (such as system 100 or others described herein) during an experimental acquisition. The graph 200 tracks a detected Total Ion Current (TIC) signal 202 over time, with the scan number on the horizontal axis corresponding to measurements taken at 66 ms increments. In the beginning of the experiment, a high-voltage power supply was connected via a feedthrough to an HECD of the detection system to maintain the HECD at a predetermined high voltage (-12 kV in this instance). The corresponding detection signal level at the beginning was approximately 2.8E8. At a scan number of about 2200 (corresponding to about 2.5 minutes from the start), the high-voltage power supply was disconnected from the HECD by physically unplugging the connection. After this disconnection, the signal immediately shows a decrease 203 by less than about half, to about 1.4E8. The signal steadily dropped further to 1.0E8 at approximately scan number 55000 (corresponding to about 60 minutes from the start), which is approximately 30% of the original signal strength. As the signal faded out linearly, the reduction was observed to be approximately 10% every 20 minutes. Such a change can be considered acceptable in many mass spectrometry applications, for example, where the application goals include confirmation of the presence or absence of particular analytes. In order to maintain detection consistency, the injection time was set to a constant value of 0.1 millisecond per scan. Also, at about scan number 27000 (corresponding to about 30 minutes from the start), a detection event occurs that produces a sharp signal peak 204, or spike, that exceeds 3E8 before returning to the steadily but slowly decreasing signal level. The return from the peak 204 to approximately the same signal level as before the spike shows that the detection capability is maintained even after occurrence of such an event and associated loss of charge on the HECD.

FIG. 2B shows a mass spectrum graph 206 for the group of ions detected during the experimental acquisition described by the chromatogram graph 200 of FIG. 2A. The spectrum containing signals from analytes in a standard calibration mix was acquired after HECD disconnection from the high-voltage supply line. As can be seen from the spectrum graph 206, a sufficient ion signal is obtained throughout the full mass range of the instrument even though the voltage supply is disconnected. This represents expected signal ratios for analytes from calibration mix with low and high m/z. For example, there is a generally accepted opinion that for lower masses a lower potential applied to the HECD would be acceptable but for higher masses a higher potential is required on the HECD. This is because the conversion process involves a kinetic interaction between the ions and the surface of the HECD to produce secondary particles that are detectable by subsequent detection components. Where a lower voltage is applied to the HECD, higher mass ions may not have sufficient velocity to produce the detectable secondary particles after colliding with the HECD. As stated above, the spectrum in graph 206 does not show a misbalance between low and high m/z, and thus after disconnection the voltage on the HECD continued to be sufficient for detection across a suitable range of m/z (e.g., with a signal dropping by no more than 30%).

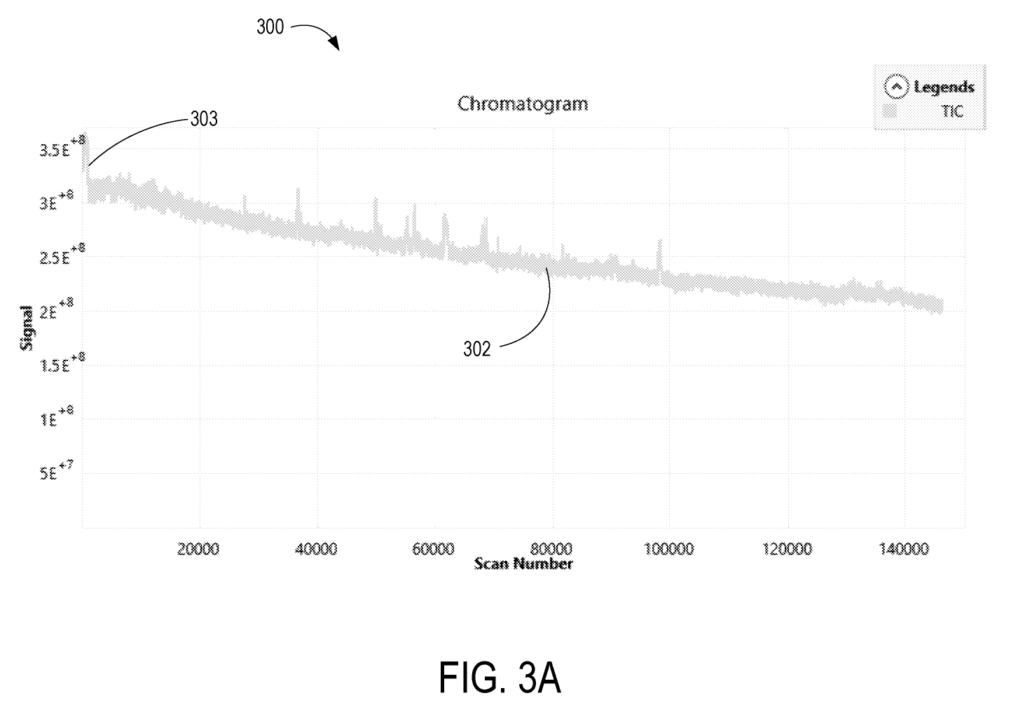

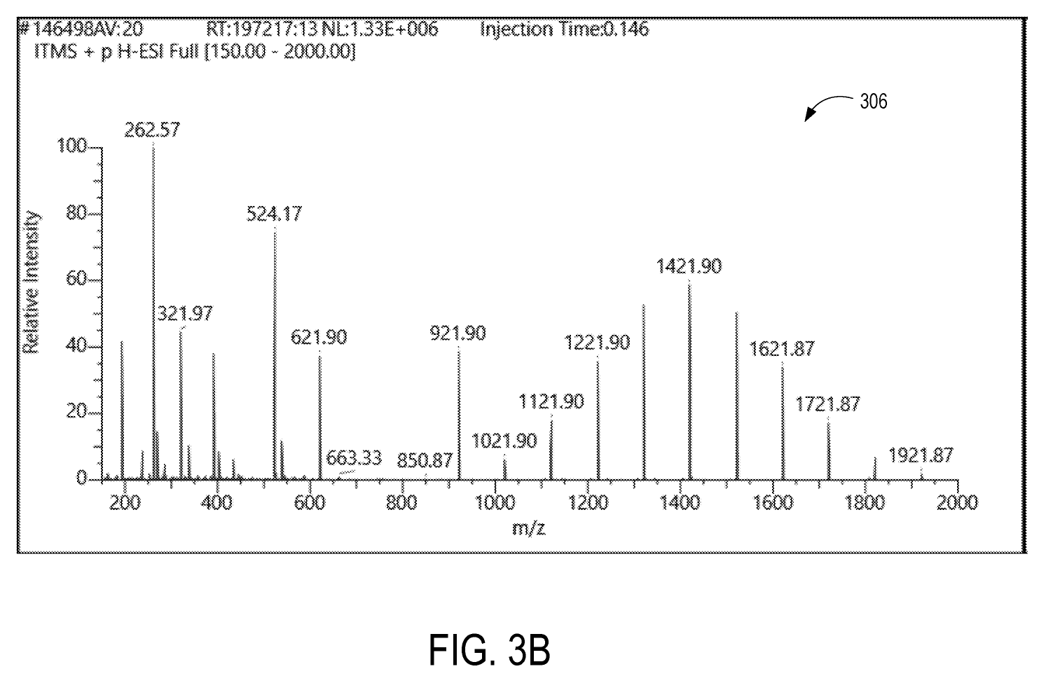

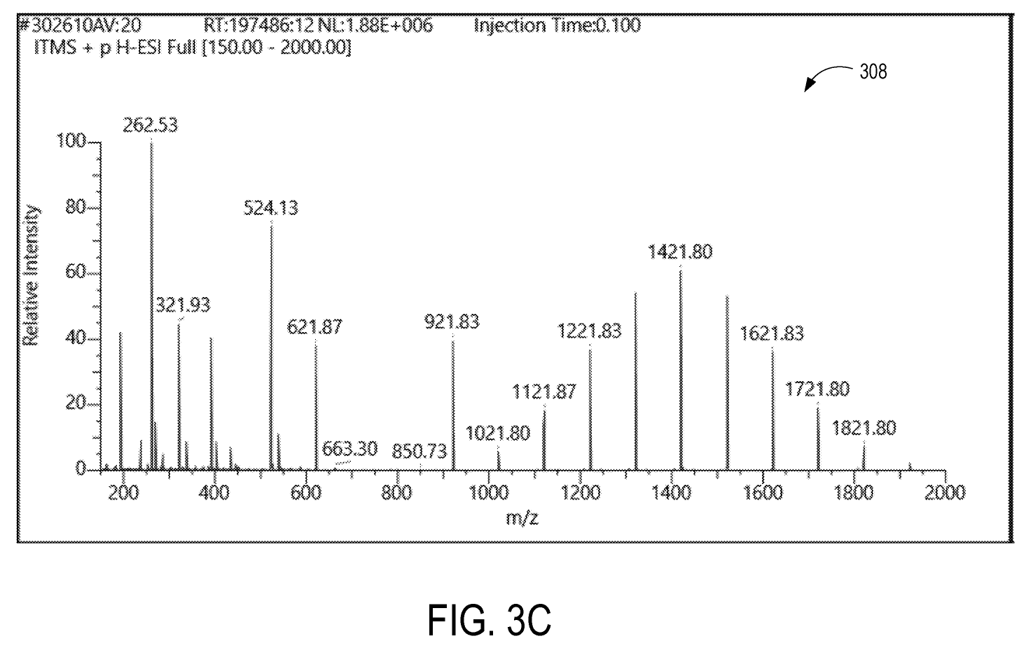

FIG. 3A is a chromatogram graph 300 of a detection signal 302 for an experimental acquisition using another example detection system similar to the system associated with graph 200, but that also includes a capacitor between its HECD and ground. The added capacitor is configured to increase capacitance for the HECD above that provided natively by the HECD network (HECD, wiring, etc.), and nearby componentry. The capacitor can mitigate signal drop upon cable disconnection and also reduce the rate of signal decrease over time after disconnection. One lead of the capacitor (which was selected to be 2 nF/15 kV for the experiment) was connected to a supply wire coupled to the HECD while the other lead of the capacitor was coupled to ground. The increase of the capacitance of the HECD network associated with the added capacitor resulted in a significantly smaller signal decrease 303 from about 3.5E8 to 3.2E8 (~9%) upon cable disconnection as compared with the approximately 50% decrease 203 shown in FIG. 2A. Also, the signal 302 decreased at a significantly slower rate of about 10% over approximately 47 min overall. Thus, upon disconnection of supplied voltage to the HECD network of the detection system, the added capacitor allows the HECD to retain the potential on the surface of the HECD and diminishes the effect of charge leak over time. Using the stated capacitor in the detection system, it is estimated that improvements of approximately 5x can be obtained with respect to signal drop upon voltage supply disconnect and about 2.4x for signal decrease rate after voltage supply disconnect as compared to the system without added capacitor. However, it will be appreciated that other capacitors and arrangements may be used, including but not limited to smaller or larger capacitances, additional capacitors, and additional electrical components.

FIGS. 3B-3C are mass spectrum graphs 306, 308 produced for ions detected using the detection system with the added capacitor associated with chromatogram graph 300. The same ions were detected as with the detection system associated with FIGS. 2A-2B. The spectrum graph 306 shows a detection spectrum obtained at minute 162 of the experiment in which the HECD is fully disconnected from its high-voltage power supply, and spectrum graph 308 shows a detection spectrum where the high-voltage power supply remains connected to maintain the HECD at 12 kV during ion detection. As can be seen from comparison of the graphs 306, 308, there is only a minor difference in detected relative intensities with and without the HECD being maintained at a high voltage by the high-voltage power supply. The absence of a significant change in relative intensities further confirms the viability of operating the detection system with the HECD uncoupled from the high-voltage power supply for a lengthy period of time that is generally sufficient to perform detection operations in many applications (e.g., 2 minutes, 10 minutes, 30 minutes, 60 minutes, etc.). Thus, a charged capacitor connected to the HECD can replace a high-voltage power supply with corresponding network while providing at least several minutes of instrument operation with acceptable signal strength and stability.

Using an HECD, the detected ion signal can be generally proportional to a voltage of the HECD, which is in turn proportional to the remaining charge of the HECD and HECD network that the HECD is a part of. The loss of charge caused by incoming ion flux can be estimated to be negligible. For example, with a typical ion flux of approximately 1E7 ions/s and a conversion efficiency of 4 electrons/ion, it would take several hours to reduce the charge of a charged 2 nF/15 kV capacitor potential by 10%. Thus, in many disclosed examples, the signal decrease over time can be attributed to leakage current from the HECD network to the ground and discharge due to collisions with particles that remain in the imperfect vacuum, rather than charge being “consumed” through collisions between incident ions and the HECD. By using lower leakage electrical components and related electrical design principles, the voltage decrease rate on the HECD can be significantly reduced. Furthermore, in view of the small current demand from HECD to provide effective detection operation, the high voltage converter used to provide the high voltage for the HECD can generally have a small configuration. For example, the voltage increase can be applied for a smaller duration which can allow the converter to be situated inside the vacuum chamber without requiring an expensive high-voltage feedthrough and network extending from the atmospheric pressure to the vacuum chamber. Such a configuration can use a less complex, less expensive, and more standard 15v or 24v vacuum feedthrough. The low voltage feedthrough can provide the low voltage to the internally situated high voltage converter to recharge the high energy conversion dynode.

Various disclosed examples can include detection systems that are operable to perform mass spectrometer detection operations with an HECD without continuously supplying and maintaining the HECD at a specific high voltage. For example, a 10% decrease in detection sensitivity over 30 minutes can be acceptable in many mass spectrometer applications. Such durations can be acceptable in portable applications, handheld, or similar mass spectrometer devices, particularly in view of the advantages that can be obtained from changes that become available with respect to the design of the high-voltage power supply subsystem. For example, a portable mass spectrometer device can operate in a pulsed regime in which a sample chamber is pumped down to a specific vacuum, but the device can remain small and lightweight due to the small portable volume and pulsed nature of the pumping scheme. In such a device, an inlet can be blocked and a sample inserted into a receiving portion. The inlet can be selectively opened to receive the sample and immediately blocked again to maintain vacuum, and the device can proceed to process the sample.

However, to support the voltage demands of the HECD, the infrastructure of conventional portable devices still tends to require sophisticated, bulky, and expensive power supplies, particularly where rapid polarity switching (e.g., to detect negative ions and positive ions) is used. The costs of such power supplies can be prohibitive, tending to be a substantial fraction of the cost of the device itself. In disclosed examples, the external source providing high voltage can have a simpler construction because it can be more simply configured to periodically charge the capacitance of the HECD without maintaining the high voltage level continuously at the same value. In some examples, in addition to not requiring larger components to maintain a continuous voltage on the HECD, the high voltage subsystem can also not require a sophisticated feedback system to measure and regulate the power supply to maintain the voltage all the time as the specified value. For example, a high-voltage power supply can be configured to charge the capacitor for a duration based on its capacitance characteristics, the capacitance characteristics of the HECD network, and a voltage and capacitance relation so that the capacitor and HECD network become sufficiently charged. This allows for the use of a high voltage power supply of simpler construction that can charge the capacitor and HECD network and that can be disconnected after they become charged. In further examples, the less onerous requirements for the size and characteristics of the high-voltage power supply can allow for alternative placements and alternative power supply configurations. For example, a high voltage converter can be smaller and positionable within the vacuum chamber thereby allowing the use of a low voltage (and therefore less dangerous) feedthrough into the vacuum chamber. In another example, a wireless power source can be configured to wirelessly transmit electrical power into the vacuum chamber to charge the HECD.

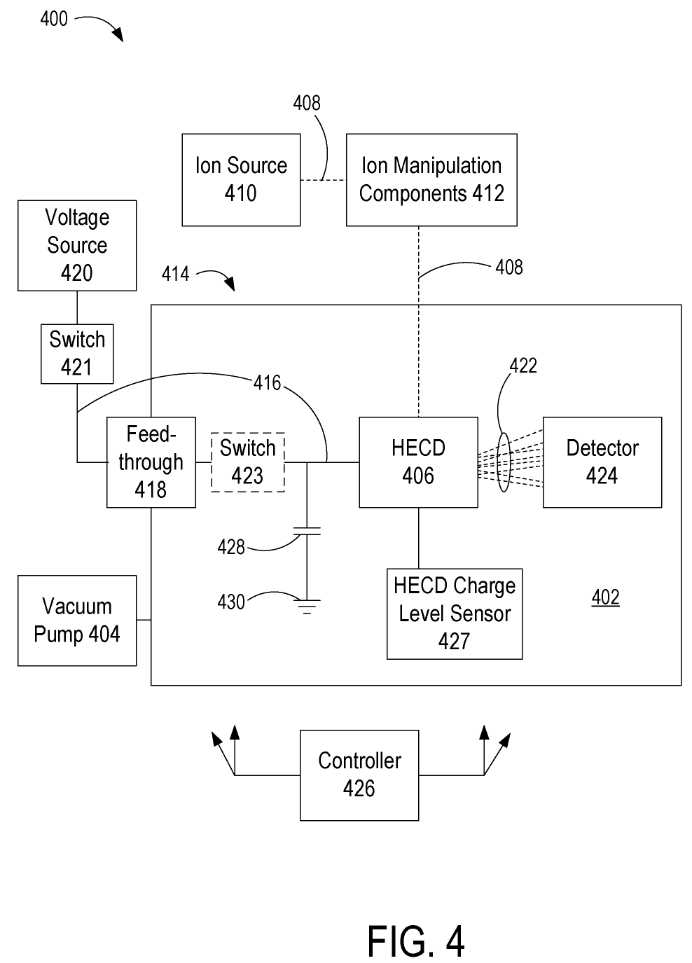

FIG. 4 is an example detection instrument 400, e.g., a mass spectrometer. The instrument 400 includes a vacuum chamber 402 that is coupled to a vacuum pump 404. The vacuum pump 404 is configured to reduce the pressure within the vacuum chamber 402 to a suitable level for detection of ions, e.g., 10⁻⁵ to 10⁻⁸ torr. A high energy conversion dynode (HECD) 406 is situated within the vacuum chamber 402 to receive ions 408 from other components of the detection instrument 400, such as an ion source 410 that can provide ions for detection (e.g., MALDI, ESI, APCI, etc.) and various ion manipulation components 412 (quadrupoles, collision cells, ion traps, ion guides, ion separators, etc.). One or more of the ion source 410 and ion manipulation components 412 can be situated within the vacuum chamber 402. The HECD 406 is part of an HECD network 414 that includes, e.g., wiring 416 and feedthrough 418. Through the wiring 416, the HECD 406 is coupled to a voltage source 420. The voltage source 420 can be configured to supply the HECD 406 with a high voltage, e.g., 5 kV to about 30 kV (more typically between about 10 kV and 15 kV). It will be appreciated that more than one dynode may be present and supplied with voltage from the voltage source 420.

During detection, ions 408 collide with a surface of the HECD 406 at a very high speed due to the high voltage of the HECD 406 to produce secondary particles 422 (such as electrons and/or positively charged ion particles). The secondary particles 422 can be detected with detector 424 which can include various components, such as electron multiplier, PMT, microchannel plate, etc. A controller 426 can be coupled to various components of the instrument 400 to control operation, such as the vacuum pump 404, ion source 410, ion manipulation components 412, voltage source 420, and/or detector 424, by way of example. The controller 426 can include one or more processors and memory configured with instructions executable by the processor(s) for carrying out the operations.

The voltage source 420 can be configured to selectively maintain a charge on the HECD 406 by alternating between supplying a high voltage and not supplying a high voltage, e.g., through a switching controlled by the controller 426 or other control device. In some examples, switching can occur through a controllable switch 421 situated outside the vacuum chamber 402 and/or through switch 423 situated inside the vacuum chamber. The HECD 406 can be configured to store the charge, e.g., through a capacitance of the HECD 406 and HECD network 414. The capacitance can be sufficient such that charge may be stored and provided for a duration sufficient to continue ion detection while the HECD 406 is not being actively charged by the coupled voltage source 420 (e.g., with the voltage source 420 being switched off or disconnected with switch 421 and/or switch 423). For example, the controller 426 can be configured to periodically cause a high voltage to be applied to the HECD 406 (e.g., through the application of high voltage pulsing). Such an application can be more simply applied without feedback, though in some examples, a voltage of the HECD can be detected directly, e.g., with a HECD charge level sensor 427 (such as a voltage meter), or inferred from various system parameters such as operational cycles, duration since a previous application, etc.

In some examples in which the HECD charge level sensor 427 is used, the controller 426 can be coupled to receive a detection signal to determine a charge state of the HECD 406, e.g., based on a capacitance of the HECD 406 and HECD network 414 and the measured voltage. In some inference examples, which may be used additionally or alternatively with examples using the HECD charge level sensor 427, the controller 426 can estimate a charge state based on the current state or states of one or more system parameters, such as one or more of a number of operational cycles, duration since a previous charging application with the voltage source 420 and an expected charge leakage rate, data from prior characterizations or calibrations of the HECD 406, an average signal strength measured by the detector 424, a number of preceding mass spectrometer runs or component activations (e.g., activations of the ion source 410 or ion manipulation components 412), an integrated signal amount produced by the detector 424, etc., may be used to estimate a charge state of the HECD 406.In some examples, the HECD 406 can be coupled to at least one capacitor 428 coupled to a ground 430. The ground 430 can be local, e.g., situated in the vacuum chamber 402. In some examples, the ground 430 can be situated externally from the vacuum chamber 402. The capacitor 428 can be configured to increase the duration over which detection can occur using the HECD 406 without the voltage source 420 actively charging the HECD 406 at a high voltage.

The instrument 400 can be configured to detect ions 408 while the HECD 406 is being charged by the voltage source 420 but can have the added ability to detect the ions 408 during times when the HECD 406 is not being charged by the voltage source 420. Durations over which detection can be provided without requiring charging from the voltage source 420 can be at least several minutes while providing acceptable signal stability during measurements. In some examples, some (e.g., a low voltage portion) or all (e.g., a low voltage and high voltage conversion portion) of the voltage source 420 may be fully external from the instrument 400, e.g., in a portable configuration. In such examples, the instrument 400 can be plugged into the external portion of the voltage source 420 to charge the HECD 406 and the capacitor 428 (if present) so that the instrument 400 can be unplugged and used portably for a duration (e.g., minutes, tens of minutes, hours, etc.).

In some examples, the instrument 400 can be configured to operate continuously and the HECD 406 (and capacitor 428, if present) can be charged periodically. The voltage source 420 can use an inexpensive low-voltage power supply and a low to high voltage converter operating in a pulsing mode. Where the feedthrough 418 is present, the HECD 406 (and capacitor 428, if present) will be periodically recharged to maintain the high voltage within an acceptable range. Such a device can remain less expensive, simpler, and smaller than currently used sophisticated and bulky high-voltage power supplies.

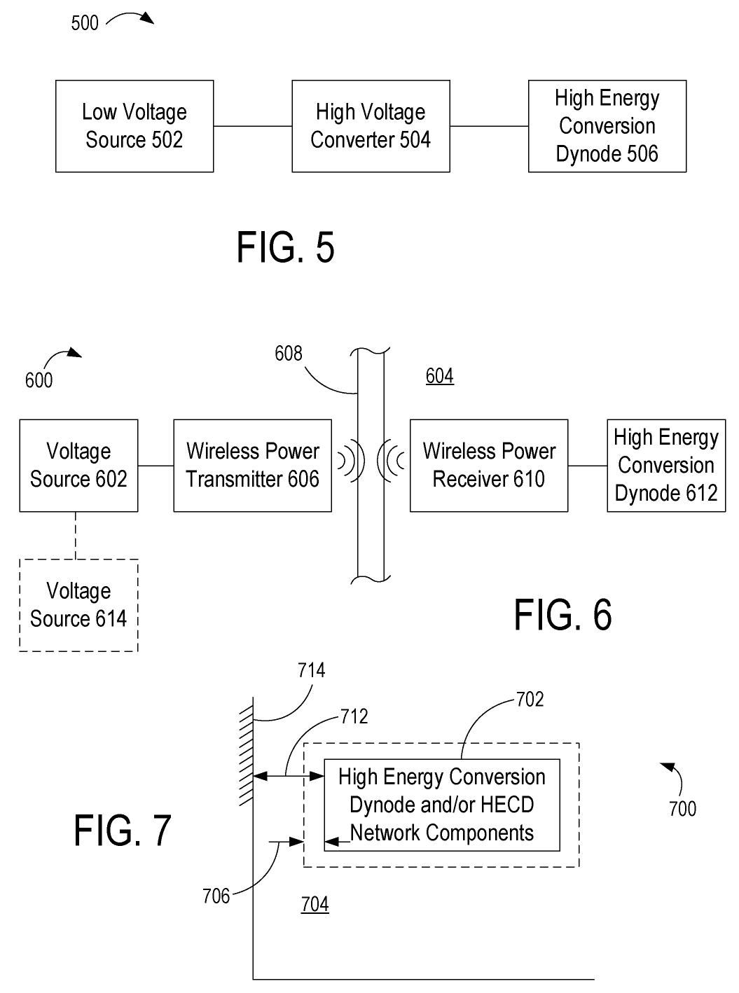

A voltage conversion arrangement 500 is shown in FIG. 5. Such an arrangement can be used in various disclosed examples herein, including but not limited to those described in relation to FIGS. 1-4 and 6-7. The arrangement 500 can include a low voltage source 502 that is coupled to a high voltage converter 504. The high voltage converter 504 can be configured to receive and convert the low voltage from the low voltage source 502 to a higher voltage, e.g., in the range of ones to tens of kV. The high voltage is coupled to a high energy conversion dynode 506 that can then be used in an ion detection process, including but not limited to any of ion detection processes described herein. In some examples, the high voltage converter 504 can be configured to apply either positive or negative voltage to the high energy conversion dynode 506, depending on ion polarity. Changing polarity for detection can involve additional durations to allow change to the charge state of the high energy conversion dynode 506. In some examples, short duration polarity switching may be used, such as consistent with examples described in US2023/0105334 “High-speed polarity switching dual conversion dynode ion detector for mass spectrometer” (incorporated by reference herein). For example, different polarity dynodes can include corresponding voltage support devices.

Various voltage sources described herein can be low voltage sources or include low voltage source portions. Low voltage sources and portions can include AC sources (such as AC mains, converted AC, etc.) and DC sources (DC outputs from AC/DC power supplies, DC/DC converters, etc). Low voltage generally refers to less than about 1 kV, less than about 200 V, or more typically between about 3 V and 50 V. High voltage generally refers to greater than about 1 kV, greater than about 5 kV, or more typically between 8 kV and 25 kV. In various examples, the high voltage converter 504 can be inside or outside a vacuum chamber within which the high energy conversion dynode 506 is situated. This can allow for the elimination of a high-voltage feedthrough into the vacuum chamber along with corresponding high voltage feedthrough cabling.

FIG. 6 is a power transmission arrangement 600 that can be used in various disclosed examples herein, including but not limited to examples described in relation to FIGS. 1-5. The power transmission arrangement 600 includes a voltage source 602 situated outside a vacuum chamber 604 (e.g., a vacuum chamber of a mass spectrometer). The voltage source 602 is coupled to a wireless power transmitter 606 that is configured to couple electrical power wirelessly through a wall 608 of the vacuum chamber 604 (which can also be referred to as a vacuum chamber in some examples) so that it can be received by a wireless power receiver 610 situated within the vacuum chamber 604. Examples of the wireless power transmitter 606 and wireless power receiver 610 can include respective coils configured to engage in near-field inductive coupling. Other arrangements can be used as well, such as capacitive coupling.

The wireless power receiver 610 can be coupled to various components in the vacuum chamber 604, such as to a high energy conversion dynode network that includes a high energy conversion dynode 612. The high energy conversion dynode 612 can be charged with the electrical energy received by the wireless power receiver 610. This can allow the high energy conversion dynode 612 to operate in an ion detection process during some or all times when the wireless power receiver 610 is not receiving power from the wireless power transmitter 606. Examples of the power transmission arrangement 600 can advantageously allow for the elimination of a low voltage and/or high voltage electrical feedthrough into the vacuum chamber 604.

In some examples, the power transmission arrangement 600 can allow for enhanced portable ion detection configurations. For example, a portable mass spectrometer instrument can include the vacuum chamber 604 in a handheld or briefcase-sized housing. The voltage source 602 or both the voltage source 602 and wireless power transmitter 606 can be separate components that are not an integral part of the portable instrument but that can be coupled to the instrument for wireless charging of the capacitance of the high energy conversion dynode 612 (or other components). In further examples, the voltage source 602 (as well as other voltage source or portions described herein) can include a removable or non-removable battery, which in many examples can be charged with a separate voltage source 614, such as an AC/DC power supply coupled to AC mains. High voltage conversion can occur inside or outside the vacuum chamber 604. With various examples of the power transmission arrangement 600, the high energy conversion dynode 612 and network can be additionally separated and insulated from the surroundings, increasing voltage stability at the high energy conversion dynode, e.g., by increasing charge retention and reducing charge leakage over time.

The capacitance for disclosed systems using high energy conversion dynodes can be increased to improve charge retention and performance. For example, an ion detection system 700 is shown in FIG. 7 which includes a set 702 of high energy conversion dynode and/or high energy conversion dynode network components situated within a vacuum chamber 704. The capacitance can be increased by a shape variation 706 of the set 702, e.g., by adding surfaces to the high energy conversion dynode through enlargement, protrusions, etc. The variation 706 can be configured to mimic capacitor shapes, e.g., with parallel surfaces and closer positioning between such surfaces. The capacitance can also be increased through the position variation 712 in relation to walled surfaces 714 of the vacuum chamber 704. In general, the increasing of capacitance for the set 702 is counterintuitive as many applications and therefore systems are optimized or designed to minimize capacitance to increase the speed of polarity switching to alternately detect ions of different polarity. That is, it is often undesirable to have high capacitance elements coupled to a high energy conversion dynode network because it requires more charge and current and correspondingly more time to produce the voltage switch. Another limitation comes from the fact that the position variation 712 should not conflict with the minimal high voltage component clearances required for discharge free operation.

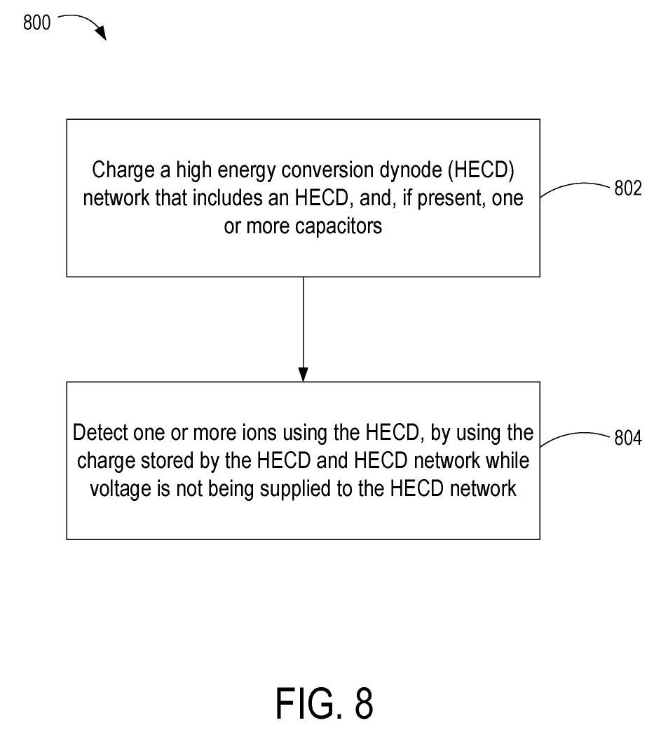

FIG. 8 is an example method 800 of operating an ion detection instrument, such as a mass spectrometer. At 802, a high energy conversion dynode (HECD) network that includes an HECD becomes charged, optionally along with one or more capacitors that are part of the HECD network. At 804, the one or more ions can be detected using the HECD kept at high voltage by the charge stored by the HECD and HECD network, while voltage is not being supplied to the HECD network. That is, the charge retention of the HECD network can be sufficient to allow for detection to occur while the HECD is not actively receiving a high voltage. This can allow for various advantages, such as increased portability, more robust operation, and/or less expensive power supply materials.

### General Considerations

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In some examples, values, procedures, or apparatus are referred to as “lowest,” “best,” “minimum,” or the like. It will be appreciated that such descriptions are intended to indicate that a selection among many used functional alternatives can be made, and such selections need not be better, smaller, or otherwise preferable to other selections.

### Additional Examples

Additional enumerated examples are listed as follows. It will be appreciated that one feature of an example in isolation or more than one feature of the example taken in combination with and optionally, in combination with one or more features of one or more further examples, are further examples also falling within the disclosure of this application.

Example 1. An ion detection system, comprising a high energy conversion dynode network including at least one high energy conversion dynode situated in a vacuum chamber; and a high voltage source coupled or couplable to the high energy conversion dynode network to selectively charge the high energy conversion dynode; wherein the ion detection system is configured to use charge stored by the high energy conversion dynode network to detect ions while the high energy conversion dynode is not being charged by the high voltage source.

Example 2. The ion detection system of Example 1, wherein the high energy conversion dynode network includes at least one capacitor configured to be charged by the high voltage source and configured to reduce a charge depletion rate of the high energy conversion dynode while the high energy conversion dynode is not being charged by the high voltage source.

Example 3. The ion detection system of any preceding Example, further comprising a feedthrough coupling at least a portion of the high voltage source situated outside the vacuum chamber to the at least one high energy conversion dynode situated inside the vacuum chamber.

Example 4. The ion detection system of Example 3, wherein the high energy conversion dynode network includes the at least one high energy conversion dynode and wiring coupling the high energy conversion dynode through the feedthrough to the voltage source.

Example 5. The ion detection system of any preceding Example, wherein the high voltage source includes a low voltage source and a high voltage converter configured to convert a low voltage of the low voltage source into a high voltage that is applied to the high energy conversion dynode network.

Example 6. The ion detection system of Example 5, wherein the high voltage converter is situated inside the vacuum chamber.

Example 7. The ion detection system of any preceding Example, further comprising a controller coupled to or couplable to the high voltage source and configured to cause the high voltage source to selectively charge the high energy conversion dynode network and to cause the ion detection system to detect ions while the high energy conversion dynode network is not being charged by the high voltage source.

Example 8. The ion detection system of Example 7, wherein the controller is configured to detect or estimate or is coupled to an HECD charge level sensor configured to detect a charge level of the high energy conversion dynode and to cause the high voltage source to charge the high energy conversion dynode in response to the detection or estimation.

Example 9. The ion detection system of any preceding Example, wherein the high energy conversion dynode and/or high energy conversion dynode network is positioned within the vacuum chamber to increase capacitance and/or includes surfaces that are configured to increase capacitance.

Example 10. The ion detection system of any preceding Example, wherein the high voltage source comprises a wireless power transmission system configured to wirelessly couple electrical power to the high energy conversion dynode network through a wall of the vacuum chamber or inside the vacuum chamber.

Example 11. The ion detection system of any preceding Example, wherein the ion detection system is configured to detect ions while the high energy conversion dynode is being charged by the high voltage source.

Example 12. A method of detecting ions with an ion detection system, comprising charging a high energy conversion dynode situated in a vacuum chamber and that is part of a high energy conversion dynode network, using a high voltage source; and detecting an ion with the high energy conversion dynode using the charge stored by the high energy conversion dynode network, while the high energy conversion dynode is not being charged by the high voltage source.

Example 13. The method of Example 12, wherein the charging the high energy conversion dynode includes charging at least one capacitor that is part of the high energy conversion dynode network, wherein the detecting the ion includes using the charge stored by the at least one capacitor to reduce a charge depletion of the high energy conversion dynode while the high energy conversion dynode is not being charged by the high voltage source.

Example 14. The method of any of Examples 12-13, wherein the charging comprises charging the high energy conversion dynode through a feedthrough that couples at least a portion of the high voltage source situated outside the vacuum chamber to the high energy conversion dynode situated inside the vacuum chamber.

Example 15. The method of Example 14, wherein the high energy conversion dynode network includes the high energy conversion dynode and wiring coupling the high energy conversion dynode through the feedthrough to the voltage source.

Example 16. The method of any of Examples 12-15, wherein the charging comprises using a low voltage source to produce a low voltage and a high voltage converter coupled to receive and convert the low voltage into a high voltage that is applied to the high energy conversion dynode network.

Example 17. The method of Example 16, wherein the high voltage converter is situated inside the vacuum chamber.

Example 18. The method of any of Examples 12-17, with a controller coupled to or couplable to the high voltage source, causing the high voltage source to selectively charge the high energy conversion dynode network and causing the ion detection system to detect ions while the high energy conversion dynode network is not being charged by the high voltage source.

Example 19. The method of Example 18, with the controller or a sensor coupled to the controller, detecting or estimating a charge level of the high energy conversion dynode and causing the high voltage source to charge the high energy conversion dynode in response to the detection or estimation.

Example 20. The method of any of Examples 12-19, wherein the high energy conversion dynode and/or high energy conversion dynode network is positioned within the vacuum chamber to increase a capacitance and/or includes surfaces that are configured to increase the capacitance.

Example 21. The method of any of Examples 12-20, wherein the charging comprises wirelessly transmitting voltage with a wireless power transmission system configured to wirelessly couple electrical power to the high energy conversion dynode network through a wall of the vacuum chamber.

Example 22. The method of any of Examples 12-21, further comprising detecting an ion with the high energy conversion dynode while the high energy conversion dynode is being charged by the high voltage source.

Example 23. The apparatus of any of Examples 1-11, wherein the high voltage source is coupled or couplable to the high energy conversion dynode to selectively charge the high energy conversion dynode through a mechanical disconnection, electrical pulsing between on and off, and/or turning the power supply on and off.

Example 24. The method of any of Examples 12-22, further comprising changing the charging to a non-charging state so that the high energy conversion dynode is not being charged by the high voltage source by mechanically disconnecting the high voltage source from the high energy conversion dynode, electrically pulsing the high voltage source to an off state, and/or turning the high voltage source off.

In view of the many possible embodiments to which the principles of the disclosed technology may be applied, it should be recognized that the illustrated embodiments are only representative examples and should not be taken as limiting the scope of the disclosure. Alternatives specifically addressed in these sections are merely exemplary and do not constitute all possible alternatives to the embodiments described herein. For instance, various components of systems described herein may be combined in function and use. We therefore claim all that comes within the scope of the appended claims.

We claim:

1. An ion detection system, comprising:
a high energy conversion dynode network including at least one high energy conversion dynode situated in a vacuum chamber; and
a high voltage source coupled or couplable to the high energy conversion dynode network to selectively charge the high energy conversion dynode;
wherein the ion detection system is configured to use charge stored by the high energy conversion dynode network to detect ions while the high energy conversion dynode is not being charged by the high voltage source.

2. The ion detection system of claim 1, wherein the high energy conversion dynode network includes at least one capacitor configured to be charged by the high voltage source and configured to reduce a charge depletion rate of the high energy conversion dynode while the high energy conversion dynode is not being charged by the high voltage source.

3. The ion detection system of claim 1, further comprising a feedthrough coupling at least a portion of the high voltage source situated outside the vacuum chamber to the at least one high energy conversion dynode situated inside the vacuum chamber.

4. The ion detection system of claim 3, wherein the high energy conversion dynode network includes the at least one high energy conversion dynode and wiring coupling the high energy conversion dynode through the feedthrough to the voltage source.

5. The ion detection system of claim 1, wherein the high voltage source includes a low voltage source and a high voltage converter configured to convert a low voltage of the low voltage source into a high voltage that is applied to the high energy conversion dynode network.

6. The ion detection system of claim 5, wherein the high voltage converter is situated inside the vacuum chamber.

7. The ion detection system of claim 1, further comprising a controller coupled to or couplable to the high voltage source and configured to cause the high voltage source to selectively charge the high energy conversion dynode network and to cause the ion detection system to detect ions while the high energy conversion dynode network is not being charged by the high voltage source.

8. The ion detection system of claim 7, wherein the controller is configured to detect or estimate or is coupled to an HECD charge level sensor configured to detect a charge level of the high energy conversion dynode and to cause the high voltage source to charge the high energy conversion dynode in response to the detection or estimation.

9. The ion detection system of claim 1, wherein the high energy conversion dynode and/or high energy conversion dynode network is positioned within the vacuum chamber to increase capacitance and/or includes surfaces that are configured to increase capacitance.

10. The ion detection system of claim 1, wherein the high voltage source comprises a wireless power transmission system configured to wirelessly couple electrical power to the high energy conversion dynode network through a wall of the vacuum chamber or inside the vacuum chamber.

11. The ion detection system of claim 1, wherein the ion detection system is configured to detect ions while the high energy conversion dynode is being charged by the high voltage source.

12. A method of detecting ions with an ion detection system, comprising:
charging a high energy conversion dynode situated in a vacuum chamber and that is part of a high energy conversion dynode network, using a high voltage source; and
detecting an ion with the high energy conversion dynode using the charge stored by the high energy conversion dynode network, while the high energy conversion dynode is not being charged by the high voltage source.

13. The method of claim 12, wherein the charging the high energy conversion dynode includes charging at least one capacitor that is part of the high energy conversion dynode network, wherein the detecting the ion includes using the charge stored by the at least one capacitor to reduce a charge depletion of the high energy conversion dynode while the high energy conversion dynode is not being charged by the high voltage source.

14. The method of claim 12, wherein the charging comprises charging the high energy conversion dynode through a feedthrough that couples at least a portion of the high voltage source situated outside the vacuum chamber to the high energy conversion dynode situated inside the vacuum chamber.

15. The method of claim 14, wherein the high energy conversion dynode network includes the high energy conversion dynode and wiring coupling the high energy conversion dynode through the feedthrough to the voltage source.

16. The method of claim 12, wherein the charging comprises using a low voltage source to produce a low voltage and a high voltage converter coupled to receive and convert the low voltage into a high voltage that is applied to the high energy conversion dynode network.

17. The method of claim 16, wherein the high voltage converter is situated inside the vacuum chamber.

18. The method of claim 12, with a controller coupled to or couplable to the high voltage source, causing the high voltage source to selectively charge the high energy conversion dynode network and causing the ion detection system to detect ions while the high energy conversion dynode network is not being charged by the high voltage source.

19. The method of claim 18, with the controller or a detector coupled to the controller, detecting or estimating a charge level of the high energy conversion dynode and causing the high voltage source to charge the high energy conversion dynode in response to the detection or estimation.

20. The method of claim 12, wherein the high energy conversion dynode and/or high energy conversion dynode network is positioned within the vacuum chamber to increase a capacitance and/or includes surfaces that are configured to increase the capacitance.
